(19) United States
(12) Patent Application Publication
(10) Pub. No.: US 2009/0289425 A1
(43) Pub. Date: Nov. 26, 2009

(54) Chuck engagement lock mechanism

(76) Inventor: Chia-Ho Lin, Wurih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,702

(22) Filed: May 20, 2009

(30) Foreign Application Priority Data
May 23, 2008 (CN) 200820111754.4

(51) Int. Cl. B23B 31/06

(52) U.S. Cl. 279/147; 279/63; 279/148

(57) ABSTRACT

This invention relates to a chuck engagement lock mechanism which mainly has a chuck head and a lower sleeve holder for clamping a tool such as a drill bit, and a rotatable joint engaged at the side edge of the lower sleeve holder. The lateral side at one end of the rotatable joint and the bottom end face of the chuck head are respectively formed with engaging teeth that can be meshed with each other for adjusting the tightness of clamping from the chuck head to the tool. A rectangular opening is provided at the other end of the rotatable joint for fitting with a hand tool having a lever. Thus, the rotatable joint can be turned by the hand tool so that users can adjust the clamping tightness of the chuck head to the tool conveniently. Thus, the chuck engagement lock mechanism of the present invention has high value in practical application and business competitiveness.

### BACKGROUND OF THE INVENTION

1. Field of the Invention

This invention relates to a chuck engagement lock mechanism, particularly to a chuck engagement lock mechanism having a rotatable joint that can be fitted with a hand tool having a lever, so that users can adjust the clamping tightness of the chuck head to the tool conveniently.

2. Brief Description of Prior Art

Lathe is a major one among machine tools to be widely utilized by industries. This is because lathe can perform various operations such as cutting, sanding, knurling, drilling, or deformation, and can be suitable for processing workpiece with different material. Accompanying with the endless progress in industry, the manufacturing of industrial products is becoming more and more sophisticated primarily due to the contribution came from improvement on machine tools such as lathe. The tools used on lathe include cutting tool and drill bit etc. A drill bit is usually disposed on chuck head and then to contact or cut workpiece. Drill bit can be exchanged at any time for ready use.

The above chuck head has an adjusting mechanism, referring to FIG. 3, in which a drill bit (61) is clamped on the bottom end of a chuck head body (6) and a chuck key (62) is provided separately from the chuck head body (6). The lateral side of one end of the chuck key and the chuck head body (6) are respectively formed with engaging teeth (621, 63), that can be meshed with each other, for adjusting the clamping tightness of the chuck head body (6) with the drill bit (61), and a grip (622) is provided on the other end of the chuck key (62). In this manner, users can turn the chuck key (62) so as to rotate the chuck head body (6).

Nevertheless, in the practical application of the above chuck head, user grips the lever of the chuck key to turn it, then the meshing action between the engaging teeth on the chuck key and the chuck head body causes the chuck head body to rotate so as to adjust the clamping tightness of the chuck head body with the tool. But user's hand force is restricted when performing the rotatable by his hand, so there is limit on the adjustment by means of this method that the drill bit might not be firmly clamped on the chuck head body. Thus, this will cause trouble for user.

### SUMMARY OF THE INVENTION

In view of the above defects, this invention provides a chuck engagement lock mechanism, comprising a rotatable joint which can be fitted with a hand tool such a sliding lever wrench or a ratchet wrench so as to turn the rotatable joint by the turning of the lever. Therefore, user can adjust the clamping tightness of the chuck head with the drill bit.

The chuck engagement lock mechanism according to a preferred embodiment of the present invention is characterized in that it mainly has a chuck head and a lower sleeve holder for clamping a tool such as a drill bit, and a rotatable joint engaged at the side edge of the lower sleeve holder, the lateral side at one end of the rotatable joint and the bottom end face of the chuck head being respectively formed with engaging teeth, that can be meshed with each other, for adjusting the clamping tightness of the chuck head with the tool, an opening for fitting is provided at the other end of the rotatable joint for fitting with a hand tool having a lever so that the rotatable joint can be turned by the hand tool.

According to the first embodiment of the chuck engagement lock mechanism of the present invention, the lower sleeve holder is provided with a hole for fitting and correspondingly the rotatable joint has a stub head which is fitted within the hole for fitting.

### BRIEF DESCRIPTION OF THE DRAWINGS

FIG. 1 is a perspective exploded view showing the first embodiment of the present invention.

FIG. 2 is a perspective exploded view showing the second embodiment of the present invention.

FIG. 3 is a perspective exploded view showing the prior art.

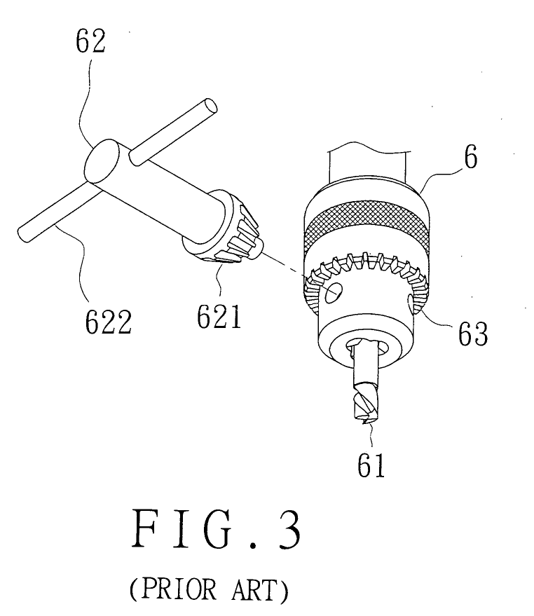

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

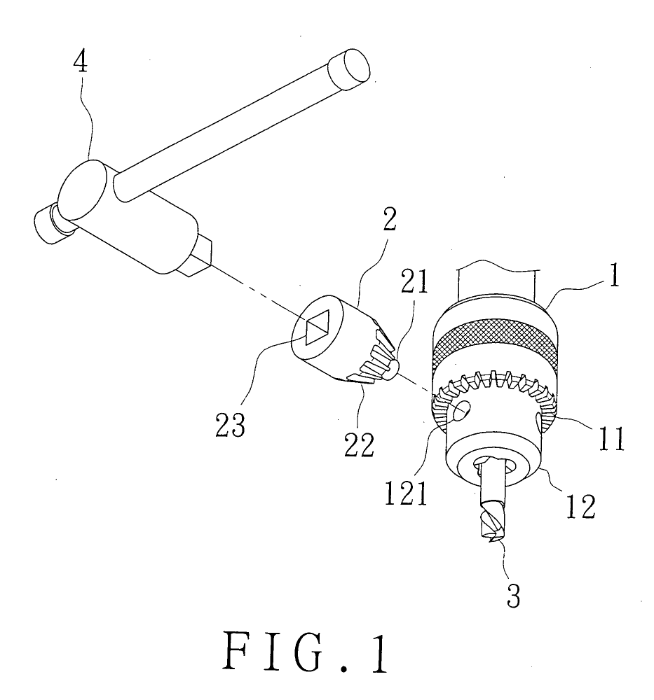

FIG. 1 is a schematic view showing the first embodiment of the chuck engagement lock mechanism of the present invention, which has a chuck head (1) and a rotatable joint (2).

The chuck head (1) is a cylindrical body the bottom end face of which is formed with engaging teeth (11) to mesh with the engaging teeth (22) formed on the rotatable joint (2). A lower sleeve holder (12) is threaded and locked on the bottom end of the chuck head (1) for cooperation with the chuck head (1) to clamp a tool (3), such as a drill bit. A through hole (121) is formed at the lateral side of the lower sleeve holder (12) for fitting with the rotatable joint (2).

A stub head (21) is provided at one end of the rotatable joint (2) which is in cylindrical shape and is corresponding to the through hole (121) at the lateral side of the lower sleeve holder (12). The rotatable joint (2) is provided with engaging teeth (22) at the lateral side of one end having stub head (21), which mesh with the engaging teeth (11) provided on the bottom end face of the chuck head (1) so as to adjust the clamping tightness of the chuck head (1) with the tool (3). A rectangular opening (23) is provided at the center of the other end of the rotatable joint (2) for fitting with a hand tool (4) having a lever. Thus, the rotatable joint (2) can be turned by the hand tool (4), such as sliding lever wrench, so as to adjust the clamping tightness of the chuck head (1) with a drill bit.

When performing the assembling, referring to FIG. 1, the stub head (21) of the rotatable joint (2) is firmly fitted in the through hole (121) at the lateral side of the lower sleeve holder (12), and the engaging teeth (22) at the lateral side of the rotatable joint (2) mesh with the engaging teeth (11) formed on the bottom end face of the chuck head (1). Then, a tool (3) is clamped by means of the chuck head (1) and the lower sleeve holder (12) together. In turn, a hand tool (4) is fitted into the opening (23) of the rotatable joint (2) for fitting with a hand tool having a lever. In this manner, the rotatable joint (2) can be turned by applying a torque on the hand tool having a lever. Inasmuch as the engaging teeth (22) of the rotatable joint (2) mesh with the engaging teeth (11) of the chuck head (1), the rotatable joint (2) will move the chuck head (1) to rotate so as to adjust the clamping tightness of the chuck head (1) with the tool (3). The hand tool (4) fitted in the opening (23) of the rotatable joint (2) in this case is a siding lever wrench by which user can conveniently turn the rotatable joint (2) so as to adjust the tightness of clamping from the chuck head (1).

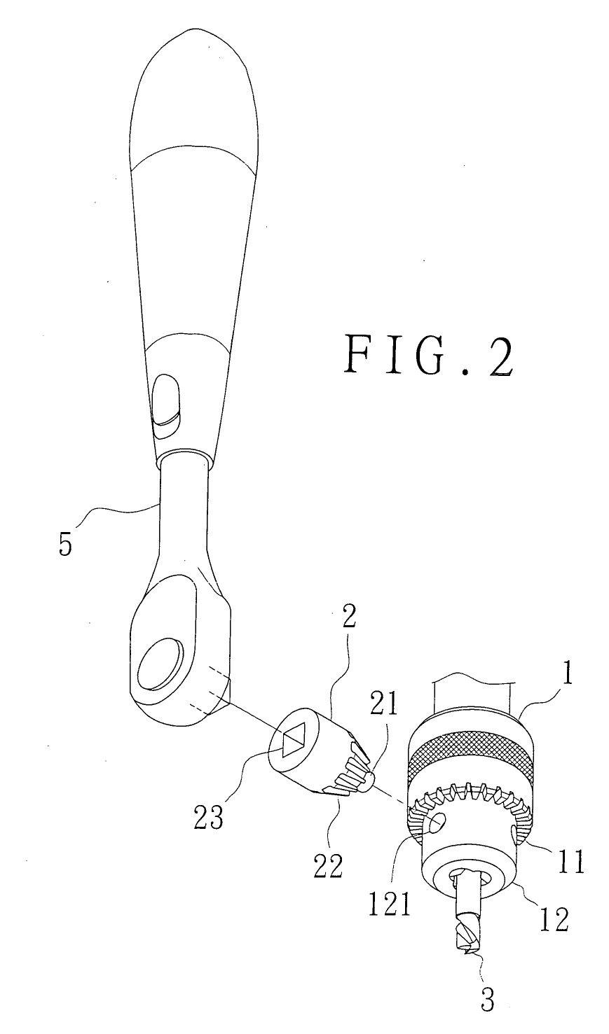

FIG. 2 is a schematic view showing the second preferred embodiment of the chuck engagement lock mechanism according to the present invention. The difference with the first preferred embodiment is that the hand tool (5) in the second preferred embodiment is a ratchet wrench. Similar to the first embodiment, the hand tool (5) is fitted into the opening (23) of the rotatable joint (2) and is served as a handle to turn the rotatable joint (2) so as to adjust the tightness of clamping from the chuck head (1) to the tool (3). In this manner, the convenience of operation is further enhanced. However, the abovementioned embodiments and drawings are not restrictive to the scope of the present invention. Appropriate variations and modifications made by the person having general knowledge in the art, such as aspect of product, fixing structure or the kind of hand tool, without departing from the spirit and scope of the present invention are still considered to be further embodiments of the present invention.

Based on the foregoing, the chuck engagement lock mechanism according to the present invention has the advantages set forth below when compared with prior art.

1. This invention is to provide a through hole at the lateral side of the lower sleeve holder and to provide a stub head at one end of the rotatable joint corresponding to the through hole of the lower sleeve holder. In this manner, users can rotate the chuck head by the rotary action came from the rotatable joint so as to adjust the clamping tightness of the chuck head.

2. An opening for fitting hand tool is provided in the rotatable joint of the present invention, which is fitted with a hand tool, such as a sliding lever wrench or a ratchet wrench, having a lever used to turn the rotatable joint. Thus, users can conveniently adjust the clamping action from the chuck head.

Summing up above, the chuck engagement lock mechanism according to this invention can reach expected effectiveness, and the specific configurations disclosed herein have yet not seen in the prior art of the same category of product, even has not been opened to the public before application.

What is claimed is:

1. A chuck engagement lock mechanism, comprising a chuck head and a lower sleeve holder, wherein said lower sleeve holder is provided with a rotatable joint which has formed with engaging teeth corresponding to the engaging teeth formed on the chuck head, and which has an opening for fitting with a hand tool.

2. A chuck engagement lock mechanism as claimed in claim 1, wherein said lower sleeve holder has a through hole, while said rotatable joint has a stub head to be fitted into said through hole.
